(19) United States
(12) Patent Application Publication
(10) Pub. No.: US 2013/0121860 A1
(43) Pub. Date: May 16, 2013

(54) RETROFIT OF A RECIPROCATING COMPRESSOR WITH A CONCENTRIC VALVE

(71) Applicants: Gene Bluhm, Springfield, MO (US); Kevin Terwelp, Payson, IL (US)

(72) Inventors: Gene Bluhm, Springfield, MO (US); Kevin Terwelp, Payson, IL (US)

(21) Appl. No.: 13/293,927

(22) Filed: Nov. 10, 2011

(51) Int. Cl. F04B 49/22; B23P 6/00

(52) U.S. Cl. 417/437; 29/888.021

(57) ABSTRACT

A first valve head is selected for removal from a piston cylinder. The first valve head has been configured to house at least a one way intake valve assembly in an intake chamber of the head and at least a one way exhaust valve assembly in an exhaust chamber of the head. The intake and exhaust chambers are sealed off from each other. The first valve head is removed from the piston cylinder. A second valve head is selected. A bottom of the second valve head is removably coupled to the piston cylinder. A concentric two way valve is seated within the second valve head. The concentric valve is secured within said second valve head with a valve clamp having a top cover. The top cover is removably coupled to the second valve head.

### CROSS-REFERENCE TO RELATED APPLICATIONS

None

### BACKGROUND OF THE INVENTION

Industrial compressors include three basic types: reciprocating, rotary screw, and rotary centrifugal. A reciprocating compressor is a positive displacement machine wherein a piston travels inside a cylinder wherein the piston intakes compressible fluid into the cylinder on a down stroke and exhausts compressible fluid by compressing the compressible fluid on the upstroke. The exhausted compressible fluid travels through a valve that prevents the exhausted compressible fluid from coming back into the cylinder. Thus, multiple reciprocations of the piston causes a volume of compressible fluid to be exhausted into a fixed volume holding tank thereby increasing the pressure inside the holding tank on every reciprocation. The piston continues its reciprocation until a desired pressure is reached in the holding tank. As the compressible fluid inside the holding tank is exhausted out of the holding tank, the piston is then reciprocated as need to maintain a desired operating pressure.

Essential components for any reciprocating compressor are the valve that allows compressible fluid to flow into the cylinder on the down stroke and the valve that allows compressible fluid to exhaust out of the cylinder during the upstroke. The valves experience millions of cycles during their operating life and when a valve fails or begins to cease to operate effectively, the efficiency and effectiveness of the compressor significantly deteriorates. FIG. 1 illustrates a very common configuration a first stage of a reciprocating compressor assembly 200. The assembly comprises a piston cylinder 202 having an inner diameter D₁ coupled to a valve head 204 with a seal 206 therebetween. The valve head 204 can also be called a cylinder head. Valve head 204 is a divided chamber head having an intake orifice 208 that allows compressible fluid to be drawn into an intake chamber 210. Two intake valve assemblies 212 are seated within intake chamber 210 and configured to allow compressible fluid to enter the cylinder 202 during the piston's down stroke. For convenience only one of the two intake valve assemblies is shown. Each valve assembly includes a body 250. The body is cylindrical and can be called a valve clamp or holder. The cylindrical body 250 carries a circular one way intake valve 253. The valve carries one or more valve plates (not shown) which move from an open to a closed position. Each valve assembly 212 is a one way, modular, self contained valve assembly. Valve head 204 further comprises at least two exhaust valve assemblies 214 configured to allow compressible fluid to flow out of cylinder 202 during the piston's up stroke into exhaust chamber 216 and subsequently out exhaust orifice 218. For convenience only one of the valve assemblies 214 is shown. Each valve assembly includes a body 254. The body is cylindrical and can be called a valve clamp or holder. The cylindrical body carries a circular one way exhaust valve 257. The valve carries one or more valve plates (not shown) which move from an open to a closed position. The valve assembly is a modular, one way, self contained valve assembly. Each body 250, 254 would also include a cap or closure (not shown) opposite the its valve. Each intake valve assembly 212 is coupled to the valve head 204 and in fluid communication with the intake chamber 210. Each valve assembly 212 extends through respective openings 210′ and 210″ of chamber 210. The openings lead into the interior of chamber 210. Each intake valve assembly 212 extends into chamber 210. Each exhaust valve assembly 214 is coupled to the valve head 204 and in fluid communication with the exhaust chamber 216. Each valve assembly 214 extends through openings 216′ and 216″ of chamber 216. The openings lead into an interior of chamber 216. Each valve assembly 214 extends into chamber 216. Chamber and openings 210, 210′, 210″ are separate, isolated and sealed off from chamber 216 and openings 216′, 216″. Valve assemblies 212 and 214 are coupled to valve head 204 with threading 220 as shown. Valve head 204 is coupled to piston cylinder 202 from above using a plurality of head fasteners 222 inserted through head apertures 227 and through cylinder apertures 224 in the cylinder flange 226 as illustrated. The valve head 204 carries a quad valve arrangement. The prior art also includes dual one way valve arrangements. In this case there is only one intake 212 and one exhaust 214 valve. The valve head is configured accordingly.

Many of these multiple valve compressors have been in operation and the valves have reached the end of their functional life. In many of these cases the individual valves have, over the years, become very difficult to remove individually as the connections become fused, or the fasteners corrode to a point that it is extremely difficult to remove the individual valve that is not operating correctly. Further, if one valve is not functioning correctly, it becomes a decision whether to replace the other valves at the same time, or wait until the other valves fail on their own. Either option results in increased maintenance costs because replacing the valve before the end of its functional life is wasteful, but paying for maintenance personnel to return to the pump to replace the valve also involves an increase in maintenance costs. Moreover, as the relative labor to material cost differential has changed, the industry maintenance standard has become to remove the entire valve head and valves and replace it with a new or rebuilt valve head including new valves already installed into the head. This method, while more cost effective than trying to replace one or both valves individually, still generates considerable waste and consumes unnecessary maintenance cost resources.

The vast majority of these compressors have a substantial remaining functional life.

### SUMMARY OF THE INVENTION

A method for retrofitting a reciprocating compressor embodies the invention. The method includes selecting for removal from a piston cylinder a first valve head. The first valve head is configured to house at least a one way intake valve assembly in an intake chamber of said head and at least a one way exhaust valve assembly in an exhaust chamber of said head. The intake and exhaust chambers sealed off from each other. The first valve head is removed from the piston cylinder. A second valve head is selected. A bottom of the second valve head is removeably coupled to the piston cylinder. A concentric two way valve is seated within the second valve head. The concentric valve is secured within the second valve head with a valve clamp having a top cover. The top cover is removably coupled to said second valve head.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views, and wherein:

FIG. 1 is a perspective view of a prior art embodiment of a quad valve head;

FIG. 2 is a perspective view of one embodiment of a valve retrofit assembly in accordance with the teachings of the present invention; and

FIG. 3 is a cross-section of the embodiment of the valve retrofit assembly of FIG. 2 taken along the line 3-3.

### DETAILED DESCRIPTION OF THE INVENTION

The following detailed description of the invention references the accompanying drawing figures that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

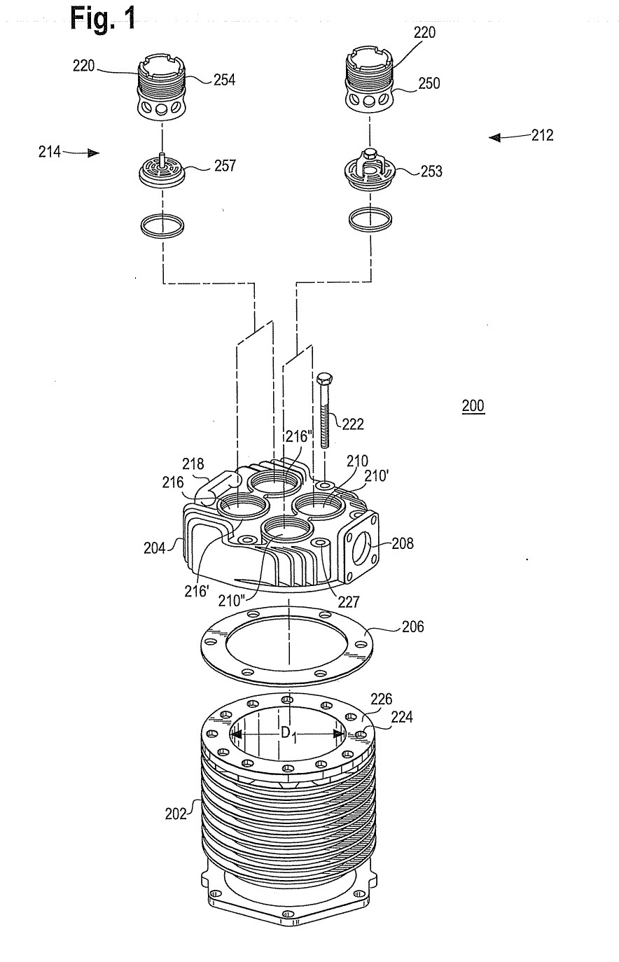

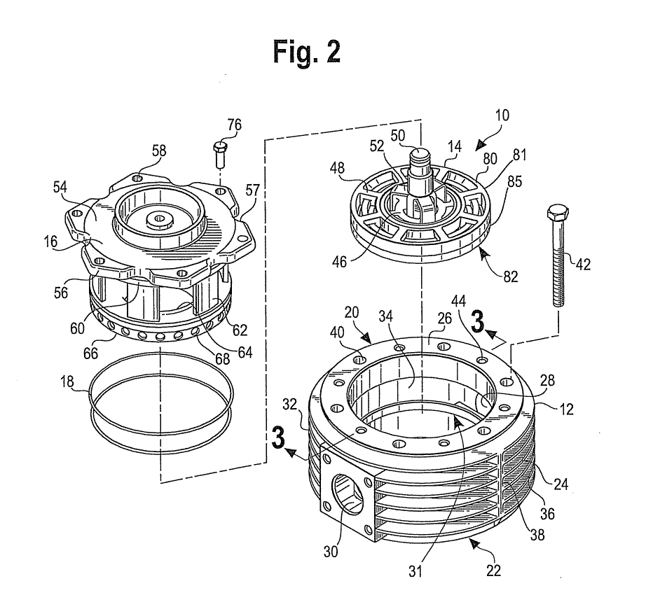

FIG. 2 provides an example of a concentric valve head assembly 10 to retrofit the existing reciprocating compressor piston cylinder 202 shown in FIG. 1 with the concentric valve head assembly shown in FIG. 2. The concentric valve head assembly 10 includes a valve head 12; a concentric valve 14 housed within valve head 12; valve clamp 16 that secures concentric valve 14 within valve head 12. The assembly also includes seals 18 for preventing intake compressible fluid and exhaust compressible fluid from escaping their designated flow path. Valve head 12 can also be called cylinder head 12. Valve head 12 includes a top 20, a bottom 22, a sidewall 24, a top flange 26, an intake orifice 28, an exhaust orifice 30 and a central hollow 31. Accordingly, sidewall 24 in part defines a substantially hollow valve head 12.

Sidewall 24 has an outer face 32 and an inner face 34 and has an axial length defined by top 20 and bottom 22 of valve head 12. Further, outer face 32 of sidewall 24 may include annular ribs 36 around its circumference and may also include vertical ribs 38 spanning substantially from bottom 22 to top 20 and radially distributed around the circumference of outer face 32 as shown. The pattern of ribs 36 and 38 may serve in part to increase the stiffness of sidewall 24. They may also provide for heat exchange with ambient air. Sidewall 24 may, alternatively, have a substantially smooth outer face and substantially uniform thickness (not shown).

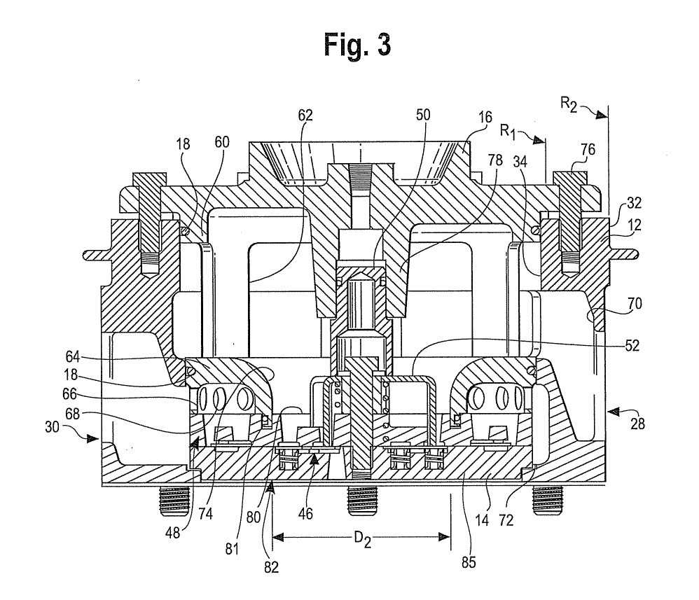

FIG. 3 shows top flange 26 extending around the circumference of top 20 of sidewall 24. Flange 26 may also be called an end wall of head 12. Top flange 26 includes a plurality of continuous head coupling apertures 40 that extend continuously and substantially vertical through top 20 and bottom 22 of sidewall 24. Head coupling apertures 40 may be distributed around the circumference of top flange 26 in a known pattern that matches the pattern of cylinder apertures 224 of existing reciprocating compressor assembly 200. Concentric valve head assembly 10 may be removably coupled to cylinder 202 of existing compressor assembly 200 with head fasteners 42 that extend through head coupling apertures 40 and into or through cylinder apertures 224. Head fasteners 42 are configured to removably couple valve head 12 to cylinder 202 of FIG. 1. Fasteners 42 and fasteners throughout this disclosure may include bolts, screws, clamps, or any other fastening method now known or hereafter developed to result to removably couple two elements. Another embodiment of the present invention could include valve head 12 being permanently coupled to a cylinder through a permanent coupling method including welds or single casting. In this case the single piece casting would replace a separately cast existing head and cylinder. The existing head and cylinder to be replaced would have the same type of one way modular valves as discussed herein

Valve head 12 may be configured and proportioned to be used with existing piston cylinders 202 of varying manufactures and diameters D₁. Top flange 26 and the pattern and location of head coupling apertures 40 thereon may be configured to match the pattern of apertures 224 on an existing piston cylinder 202 of various manufacturers now known or hereafter developed. In this manner, a user may select a valve head 12 configured to be used with the piston cylinder 202 of a certain manufacturer having a certain size.

Concentric valve 14 is a single modular element that performs dual functions and replaces the necessity of two one way valves. Concentric valve 14 is divided into at least two operable portions including an intake portion 46 and an exhaust portion 48. One embodiment of concentric valve 14 has a circular shape and includes intake portion 46 including and surrounding the center of concentric valve 14 and exhaust portion 48 occupying the outer ring of concentric valve 14 as best shown in FIG. 3. One embodiment of the present invention can include intake portion 46 and exhaust portion 48 having substantially identical areas. Concentric valve 14, includes two circular plates combined in one element. Valve 14 provides valved flow of fluid in at least two substantially opposing directions. A first plate 81 is at the top 80. A second plate 85 is at the bottom 82. The two plates are circular and can be called circular discs. The construction of concentric valves is known in the art and any such construction now known or hereafter developed may be incorporated into valve head assembly 10 of the present invention. Concentric valve 14 may also include a push rod assembly which includes a spring loaded plunger 50 whose main function is to move fingers 52 down thus holding the intake portion of valve 14 open and thus stopping the compression process. Air flows into intake 46 and back out without compression.

FIG. 2 further shows valve clamp 16 including a top cover 54 that may include coupling tabs 56. A recessed portion 57 is between each tab. Each tab has an aperture 58 there through. The configuration ensures that tabs 56 fit in-between head fasteners 42 when fasteners 42 are in an installed position in apertures 44 and the head 12 is coupled to cylinder 202. Valve clamp 16 further includes an upper ring 60, a plurality of vertical legs 62 positioned between upper ring 60 and a flow diverter 64, and an exhaust rim 66 extending downwardly from flow diverter 64. Vertical legs 62 are coupled to upper ring 58 and flow diverter 64 and distributed around the perimeter of upper ring 60 and flow diverter 64 to provide a plurality of voids for fluid flow therebetween. Exhaust rim 66 includes a plurality of exhaust apertures 68 through exhaust rim 66 and distributed around the circumference of exhaust rim 66 as shown in FIG. 2 to allow compressible fluid to flow out of exhaust rim 66. One o-ring 18 is seated on and around upper ring 60 and the other o-ring 18 is seated on and around flow diverter 64.

Now turning to FIG. 3, assembled valve head assembly 10 of the present invention is illustrated in cross section. As shown, inner face 34 of sidewall 24 is positioned at a radius R₁ from the center of valve head 12 and defines a single axially extending hollow passage way therethrough and outer face 32 is located at a radius R₂ from the center of valve head 12 wherein the difference between R₂ and R₁ substantially defines the thickness of sidewall 24. Inner face 34 of sidewall 24 of valve head 12 further includes a recessed portion 70 around the entire circumference thereof as shown. This recessed portion substantially aligns with the position of intake orifice 28. Further, inner face 34 of sidewall 24 includes a valve seat 72 that concentric valve 14 bears upon within valve head 12.

As shown, a portion of the circular valve plate at the bottom 82 of concentric valve 14 is seated on valve seat 72 and valve clamp 16 is inserted within the hollow defined by inner face 34 of valve head 12 such that exhaust rim 66 of valve clamp 16 bears against top 80 of concentric valve 14. Concentric valve 14 may also be nested against inner face 34 of sidewall 24 by any other means known in the art including the outside of concentric valve being angled upward and outward and being wedged into a portion of inner face 34 similarly configured to receive concentric valve 14. As further shown in FIG. 3, legs 62 are at the substantially same vertical position as intake orifice 28. Each orifice 28 and 30 are in fluid communication with concentric valve 14. Flow diverter 64 comprises a curved wall 74 that also bears against concentric valve 14 separating the intake portion 46 from exhaust portion 48 of concentric valve 14 thereby separating the intake and exhaust fluid flow. Curved wall 74 of flow diverter 64 defines an opening having a diameter D₂ that substantially corresponds to the diameter of the intake portion of concentric valve 14. Flow diverter 64 and the configuration of valve head 12 and valve clamp 16 generally provides intake portion 46 of concentric valve 14 being in fluid communication with intake orifice 28 and exhaust portion 48 of concentric valve 14 being in fluid communication with exhaust orifice 30. One embodiment of valve assembly 10 may include a downward extending rod 78 of top cover 54 of valve clamp 16 encircling a portion of plunger 50.

To secure concentric valve 14 within valve head 12 with valve clamp 16, a plurality of clamp fasteners 76 are inserted through apertures 58 of top cover 54 of valve clamp 16 and into clamp apertures 44 of top flange 26 and operated to removably couple valve clamp 16 to valve head 12. One or more seals or o-rings 18 may be positioned on upper ring 60 of valve clamp 16 or any component thereof to prevent compressible fluid from exiting around the valve clamp 16 and out the valve head 10 as shown in FIG. 3. Additional seals or o-rings 18 may be positioned on and around the flow diverter 64 of valve clamp 16 to prevent fluid from exiting out of valve head 10 in an undesired path.

Valve head assembly 10 of the present invention is used to retro-fit existing piston cylinders 202 of a reciprocating compressor assembly 200 by replacing a quad-valve valve head 204 with valve head assembly 10 that incorporates a concentric valve 14. Replacing quad-valve head 204 with valve head assembly 10 results in more efficient operation of the reciprocating compressor and substantially reduces maintenance costs with respect to replacing warn out valves. To affect replacement, a user will first remove the existing quad-valve head 204 and all the valves 212 and 214. The head is removed with the valves by releasing a plurality of fasteners 222. Seal 206 is removed and cylinder flange 226 of piston cylinder 202 is cleaned and prepared to receive valve head 12 of valve assembly 10. A replacement seal, sealant, or combination thereof may be placed between valve head 12 and cylinder flange 226 to provide an air-tight seal. Although FIG. 1 shows a quad valve, it is within the scope of the invention to replace a dual valve head. In this case the valve head replaced only carries one intake valve 212 and one exhaust valve 214.

Valve head 12 is placed in contact with cylinder flange 226 and aligned such that head coupling apertures 40 are aligned with apertures 224 in cylinder flange 226. Head fasteners 42 are inserted into and extended through head coupling apertures 40 and are extended through or received by apertures 224 through flange 226. Fasteners 42 may be tightened to securely and removably couple valve head 12 to piston cylinder 202.

Concentric valve 14 is placed into hollow valve head 12 such that a portion of the circular plate form the bottom 82 of concentric valve 14 rests upon valve seat 72. Valve clamp 16 is inserted into hollow valve head 12 such that exhaust rim 66 bears against top valve 81 of concentric valve 14 and downward extending arm or protrusion 78 of top cover 26 encircles plunger 50. In one embodiment of the present invention, plunger 50 may be displaced slightly downward to hold the inlet portion of valve 14 open and stop compression. Valve clamp 16 is then positioned such that apertures 58 align with clamp apertures 44 on top flange 26. Fasteners 76 are inserted through apertures 58 and are received into clamp apertures 44 to couple valve clamp 16 to valve head 12. Existing intake and exhaust pipes may be coupled to valve head 12 and the reciprocating compressor is ready for operation.

In operation, when the piston in piston cylinder 202 is stroked and repeatedly translated upward and downward within piston cylinder 202, compressible fluid is drawn in through intake orifice 28 of valve head 12 during the down stroke wherein the fluid flows through the voids between vertical legs 62 and is diverted by curved wall 74 of flow diverter 64 into intake portion 46 of concentric valve 14. Intake portion 46 of concentric valve 14 opens to allow intake compressible fluid to be drawn into cylinder 202. Upon the up-stroke of the piston 228 within cylinder 202, compressible fluid in cylinder 202 is compressed upward. Intake portion 46 of concentric valve 14 closes and exhaust portion 48 of concentric valve 14 opens allowing compressible fluid to be forced out of cylinder 202, through concentric valve 14 and apertures 68 in exhaust rim 66 and out exhaust orifice 30. The Piston of the reciprocating compressor 200 cycles repeatedly until one or both of concentric valve portions 46 of 48 wears out.

At this point, a user will remove valve clamp 16 by releasing or removing fasteners 76 and pulling valve clamp 16 upward and out of hollow valve head 12. The user may then remove concentric valve 14 by pulling it upward off of seat 72 and remove it from valve head 12. The user may then insert a new concentric valve 14 such that new concentric valve 14 seats on valve seat 72 and the user may then re-insert valve clamp 16 into hollow valve head 12 and couple top cover 54 to valve head 12 as described above.

The retro-fit of an existing reciprocating compressor with the valve head assembly 10 of the present invention as described above substantially reduces the time and materials required to maintain the reciprocating compressors and increases the efficiency of the existing compressors by allowing the valve to be immediately proximate the piston of the reciprocating compressor.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

I claim:

1. A method for retrofitting a reciprocating compressor comprising:
selecting for removal from a piston cylinder a first valve head, said first valve head having been configured to house at least a one way intake valve assembly in an intake chamber of said head and at least a one way exhaust valve assembly in an exhaust chamber of said head, said intake and exhaust chambers sealed off from each other;
removing said first valve head from said piston cylinder;
selecting a second valve head;
removably coupling a bottom of the second valve head to said piston cylinder;
seating a concentric two way valve within said second valve head;
securing said concentric valve within said second valve head with a valve clamp having a top cover; and
removably coupling said top cover to said second valve head.

2. The method for retrofitting a reciprocating compressor of claim 1 wherein said second valve head has apertures configured to match a pattern of apertures on said piston cylinder.

3. The method for retrofitting a reciprocating compressor of claim 1 wherein said concentric valve is a single modular element.

4. The method for retrofitting a reciprocating compressor of claim 3 wherein said concentric valve includes an intake portion surrounding a center of said concentric valve and an exhaust portion occupying an outer ring of said concentric valve, said concentric valve having a first circular plate at a top of said concentric valve and a second circular plate at a bottom of said centric valve.

5. The method for retrofitting a reciprocating compressor of claim 1 further comprising aligning a plurality of apertures of said top cover with a plurality of clamp apertures in said second valve head, wherein said apertures in said top cover are in tabs of said top cover and said tabs are defined by recesses between said tabs.

6. The method for retrofitting a reciprocating compressor of claim 5 further comprising aligning said tabs between a plurality of valve head apertures in said second valve head.

7. The method for retrofitting a reciprocating compressor of claim 1 further comprising nesting said concentric valve against an inner face of a sidewall of said second valve head.

8. The method for retrofitting a reciprocating compressor of claim 1 further comprising bearing an exhaust ring of said valve clamp against a top of said concentric valve.

9. The method for retrofitting a reciprocating compressor of claim 4 further comprising seating a portion of said second valve plate on a valve seat.

10. The method for retrofitting a reciprocating compressor of claim 4 further comprising orienting said exhaust portion of said concentric valve to be in fluid communication with an exhaust orifice of said second valve head.

11. The method for retrofitting a reciprocating compressor of claim 4 further comprising orienting said intake portion of said concentric valve to be in fluid communication with an intake orifice in said valve head.

12. The method for retrofitting a reciprocating compressor of claim 5 further comprising inserting fasteners through said apertures in said tabs and into said clamp apertures of said second valve head.

13. The method for retrofitting a reciprocating compressor of claim 6 further comprising inserting fasteners between said recesses and into said head apertures.

14. The method for retrofitting a reciprocating compressor of claim 1 further comprising positioning a first o-ring to prevent compressible fluid from exiting around said valve clamp and out said second valve head.

15. The method for retrofitting a reciprocating compressor of claim 1 further comprising positioning a second o-ring to prevent compressible fluid from exiting around said valve clamp and out said second valve head.

16. An assembly of a compressor comprising:
a piston cylinder;
a valve head removably coupled to said piston cylinder;
a concentric two way valve carried by said valve head;
a valve clamp removably coupled to said valve head, said valve clamp extending into a central hollow of said valve head, said valve clamp contacting said concentric valve.
